(19) United States
(12) Patent Application Publication
(10) Pub. No.: US 2026/0073663 A1
(43) Pub. Date: Mar. 12, 2026

(54) DATA ANALYSIS APPARATUS, METHOD, AND NON-TRANSITORY COMPUTER-READABLE STORAGE MEDIUM

(71) Applicant: KABUSHIKI KAISHA TOSHIBA, Kawasaki-shi (JP)

(72) Inventors: Yasutaka FURUSHO, Tokyo (JP); Shuhei NITTA, Tokyo (JP)

(73) Assignee: KABUSHIKI KAISHA TOSHIBA, Kawasaki-shi (JP)

(21) Appl. No.: 19/312,742

(22) Filed: Aug. 28, 2025

(30) Foreign Application Priority Data
Sep. 10, 2024 (JP) 2024-156626

(51) Int. Cl. G06V 10/762; G06V 10/75

(52) U.S. Cl. CPC G06V 10/7635; G06V 10/751

(57) ABSTRACT

According to one embodiment, a data analysis apparatus includes processing circuitry. The processing circuitry acquires a plurality of items of subject data, trains a first training model using the items of subject data based on a first training criterion including a plurality of training elements related to the items of subject data, and generates a plurality of first feature vectors corresponding to the items of subject data, generates a first clustering result by clustering the first feature vectors, trains a second training model using the items of subject data based on a second training criterion different from the first training criterion, and generate a plurality of second feature vectors corresponding to the items of subject data, and generates a comparison result by comparing the first feature vectors and the second feature vectors for each of a plurality of clusters based on the first clustering result.

### CROSS-REFERENCE TO RELATED APPLICATIONS

This application is based upon and claims the benefit of priority from Japanese Patent Application No. 2024-156626, filed Sep. 10, 2024, the entire contents of which are incorporated herein by reference.

### FIELD

Embodiments described herein relate generally to a data analysis apparatus, method, and a non-transitory computer-readable storage medium

### BACKGROUND

Conventionally, a technique for evaluating clustering by an evaluation value based on data dispersion in a cluster and a distance between clusters is known. However, in this technique, in clustering based on a training criterion configured by a plurality of training elements, it may not be known what kind of training element affects and separates a certain cluster and another cluster.

### BRIEF DESCRIPTION OF THE DRAWINGS

FIG. 1 is a block diagram illustrating a configuration of a data analysis apparatus according to an embodiment.

FIG. 2 is a block diagram illustrating a specific configuration of a first training unit in FIG. 1.

FIG. 3 is a block diagram illustrating a specific configuration of a second training unit in FIG. 1.

FIG. 4 is a flowchart illustrating an operation of a data analysis apparatus according to the embodiment.

FIG. 5 is a diagram illustrating a specific example of an image according to the embodiment.

FIG. 6 is a table in which an image and a flexural strength score are associated with each other according to the embodiment.

FIG. 7 is a flowchart illustrating a specific example of first training processing of the flowchart of FIG. 4.

FIG. 8 is a flowchart illustrating a specific example of second training processing of the flowchart of FIG. 4.

FIG. 9 is a diagram illustrating a specific example of a display image including a scatter diagram visualizing a first clustering result according to the embodiment.

FIG. 10 is a diagram illustrating a specific example of a display image including a scatter diagram visualizing a second clustering result according to the embodiment.

FIG. 11 is a diagram illustrating a first specific example of a display image including a figure indicating a correspondence relationship between different scatter diagrams in the embodiment.

FIG. 12 is a diagram illustrating a second specific example of a display image including a figure indicating a correspondence relationship between different scatter diagrams in the embodiment.

FIG. 13 is a block diagram illustrating a hardware configuration of a computer according to an embodiment.

### DETAILED DESCRIPTION

In general, according to one embodiment, a data analysis apparatus includes processing circuitry. The processing circuitry acquires a plurality of items of subject data, trains a first training model using the items of subject data based on a first training criterion including a plurality of training elements related to the items of subject data, and generates a plurality of first feature vectors corresponding to the items of subject data, generates a first clustering result by clustering the plurality of first feature vectors, trains a second training model using the items of subject data based on a second training criterion different from the first training criterion, and generate a plurality of second feature vectors corresponding to the items of subject data, and generates a comparison result by comparing the plurality of first feature vectors and the plurality of second feature vectors for each of a plurality of clusters based on the first clustering result.

Hereinafter, embodiments of a data analysis apparatus will be described in detail with reference to the drawings.

### Embodiment

In the present embodiment, an example will be described in which an image (hereinafter, referred to as an SEM image) obtained by imaging a cross section of a product (for example, a silicon nitride substrate) with a scanning electron microscope (SEM) or the like and a score (intensity score) representing a flexural strength of the product (substrate) are used as data (hereinafter, referred to as subject data) to be analyzed by a data analysis apparatus. In addition, the data analysis apparatus uses a training model of machine learning (machine learning model) that learns the SEM image, the intensity score, and the like. As the machine learning, for example, a deep neural network (DNN) is used. That is, the machine learning model of the embodiment is a DNN model.

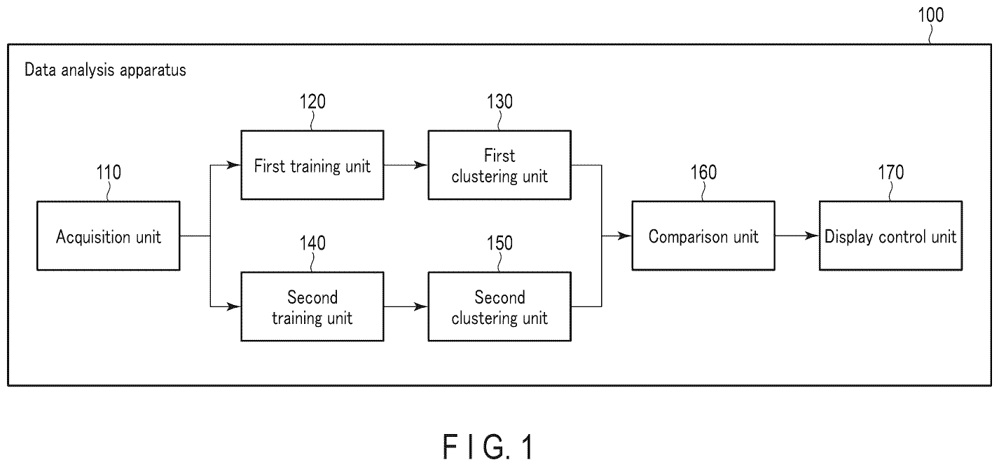

FIG. 1 is a diagram illustrating a configuration example of a data analysis apparatus according to an embodiment. The data analysis apparatus 100 in FIG. 1 includes an acquisition unit 110, a first training unit 120, a first clustering unit 130, a second training unit 140, a second clustering unit 150, a comparison unit 160, and a display control unit 170.

The acquisition unit 110 acquires a plurality of items of subject data. The subject data includes image data representing an SEM image and an intensity score associated with the SEM image (image data). The acquisition unit 110 outputs a plurality of items of subject data to the first training unit 120 and the second training unit 140.

In a specific example of the embodiment, the image data of the subject data is, for example, a black-and-white image having an image size of 32×32 pixels. That is, the subject data is a vector data group of a 32×32 1024 dimensional vector. Note that the subject data may be referred to as training data.

Furthermore, the acquisition unit 110 may acquire a first training condition and a second training condition. At this time, the acquisition unit 110 outputs the first training condition to the first training unit 120 and outputs the second training condition to the second training unit 140. Hereinafter, an outline of the training condition common to the first training condition and the second training condition will be described.

The above training condition includes, for example, a model structure, a structure parameter, a loss function, a regularization term, and an optimization parameter of the DNN. Examples of the model structure of DNN include Vision Transformer (ViT), ResNet, MobileNet, and EfficientNet specialized for image classification. The structure parameter includes, for example, the number of network layers, the number of nodes in each layer, a connection method between the layers, and the type of activation function used in each layer. The loss functions include, for example, mean squared error (MSE) and L2 loss, and a simple framework for contrastive learning of visual representations (SimCLR), Bootstrap Your Own Latent (BYOL), and Brlow Twins. Examples of the regularization term include L1 regularization and L2 regularization. The optimization parameter includes, for example, a type of optimizer (Momentum Stochastic Gradient Descent (SGD), Adaptive moment estimation (Adam), and the like), a learning rate (or a learning rate schedule), the number of updates (the number of times of iterative training), the number of mini-batches (mini-batch size), and the intensity of WeightDecay. In addition, the training condition includes a training criterion to be described later.

The first training unit 120 receives a plurality of items of subject data from the acquisition unit 110. The first training unit 120 trains a first machine learning model under a first training condition using a plurality of subject data. The first training condition includes a first training criterion to be described later. The first training unit 120 outputs a plurality of first feature vectors by inputting a plurality of items of subject data to a first trained model that is a first machine learning model for which training has been completed. The first training unit 120 outputs a plurality of first feature vectors to the first clustering unit 130.

The training criterion described above includes one or more training elements. The training element is defined as, for example, a combination of data used to learn a machine learning model and an objective function (loss function) according to a type of data. For example, the first training criterion includes a first training element and a second training element. The first training element is, for example, a combination of image data included in the subject data and a loss function in unsupervised learning of the image data. The second training element is a combination of the intensity score included in the subject data and the loss function in the supervised learning of the intensity score. A second training criterion to be described later is, for example, different from the first training criterion, and includes only the first training element. In other words, the second training criterion may be a subset of the first training criterion. Note that the training criterion may include a regularization term (for example, L1 regularization and L2 regularization) for the loss function.

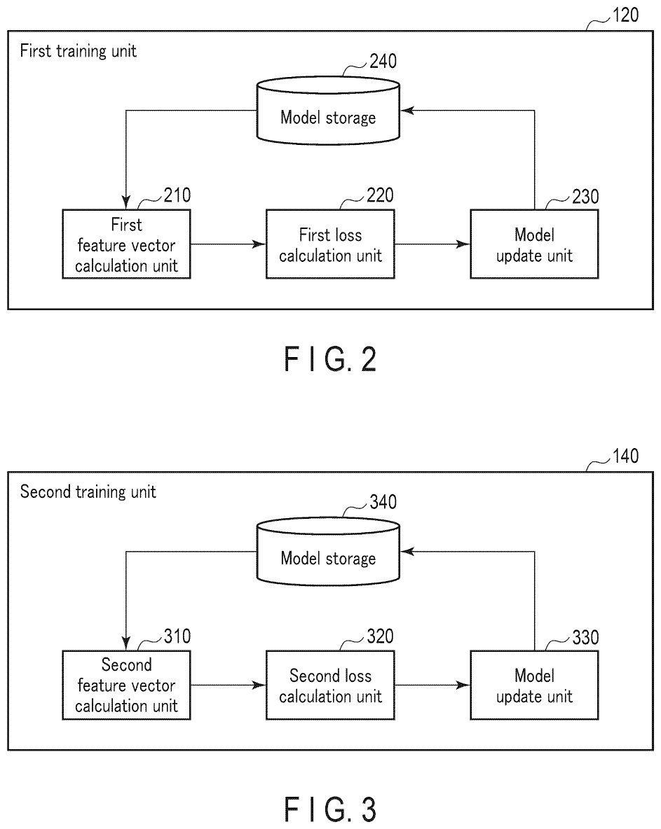

Furthermore, in a case where the acquisition unit 110 has acquired the first training condition, the first training unit 120 may receive the first training condition from the acquisition unit 110. Furthermore, the first training unit 120 may set a first training condition for training of the first machine learning model. Hereinafter, a specific configuration of the first training unit 120 will be described with reference to FIG. 2.

FIG. 2 is a block diagram illustrating a specific configuration of the first training unit in FIG. 1. The first training unit 120 in FIG. 2 includes a first feature vector calculation unit 210, a first loss calculation unit 220, a model update unit 230, and a model storage 240. In each of the following units, processing of one subject data of the plurality of items of subject data will be described.

The first feature vector calculation unit 210 calculates a first feature vector based on the subject data. Specifically, the first feature vector calculation unit 210 outputs (calculates) the first feature vector by inputting the subject data to a first machine learning model stored in the model storage 240. The first feature vector calculation unit 210 outputs the calculated first feature vector to the first loss calculation unit 220. Note that, in the present embodiment, the first feature vector is, for example, 128 dimensional vector data output from an output layer of the DNN.

Note that the first feature vector calculation unit 210 outputs the first feature vector output from an output layer of the DNN in the calculation of the first loss by training of the first machine learning model. On the other hand, after training of the first machine learning model, the first feature vector calculation unit 210 may output the output of an intermediate layer before an output layer (for example, several layers before the output layer) as the first feature vector.

The first loss calculation unit 220 receives the first feature vector from the first feature vector calculation unit 210. The first loss calculation unit 220 calculates the first loss using the first feature vector. The first loss calculation unit 220 outputs the first loss to the model update unit 230.

Specifically, the first loss calculation unit 220 calculates a first loss L₁ using SimCLR, which is one of unsupervised learning methods, and an L₂ loss, for example. Hereinafter, the loss using SimCLR is referred to as a first partial loss PL₁, and the loss using using L₂ loss is referred to as a second partial loss PL₂. Note that the first partial loss PL₁ is calculated, for example, with respect to the image data (the material tissue pattern of the SEM image) based on the first training element, and the second partial loss PL₂ is calculated with respect to the intensity score predicted from the image data based on the second training element.

The first partial loss PL₁ using SimCLR can be obtained by, for example, the following Expressions (1) and (2).

$$ℓ ( i , j ) = - log \frac{exp ( sim ( {𝓏}_{i} , {𝓏}_{j} ) / τ )}{{\sum }_{k = 1}^{2 N} {1}_{[ k \neq i ]} exp ( sim ( {𝓏}_{i} , {𝓏}_{j} ) / τ )} \qquad ( 1 )$$

$${PL}_{1} = \frac{1}{2 n} {\sum }_{k = 1}^{N} [ ℓ ( 2 k - 1 , 2 k ) + ℓ ( 2 k , 2 k - 1 ) ] \qquad ( 2 )$$

In Expression (1), N represents the number of subject data used for loss calculation (the number of image data) (this corresponds to the mini-batch size in a case where stochastic optimization is performed), and i and j represent serial numbers of two types of samples augmented from the same image data by data augmentation. In SimCLR, since two types of samples obtained by data augmentation from one image data are used, the total number of samples is 2N.

Further, an indication function 1_{[k+i]} represents a function that becomes 1 in the case of k≠1 and becomes 0 in other cases, and sim (A, B) represents a function (for example, a cosine function) that outputs a larger numerical value as the similarity between A and B is higher. Further, z represents an output vector (feature vector) of the DNN, a subscript (for example, i, j, and k) of z represents a serial number of the image data, and represents a temperature parameter related to a loss. The temperature parameter t can balance the sensitivity of the numerical value output by the sim function, and is set such that the smaller the value, the higher the sensitivity, and the larger the value, the lower the sensitivity.

In other words, the first loss calculation unit 220 calculates the first partial loss using a method (for example, SimCLR) in which the smaller the error between two different feature vectors obtained from the same subject data and the larger the error between two different feature vectors obtained from different image data, the smaller the loss.

The second partial loss PL₂ using the L₂ loss can be obtained by, for example, the following Expression (3).

$${PL}_{2} = \frac{1}{N} {{\sum }_{k = 1}}^{N} {‖ {\hat{y}}_{k} - {y}_{k} ‖}_{2}^{2} \qquad ( 3 )$$

In Expression (3), N represents the number of subject data (the number of image data) used for loss calculation (this corresponds to the mini-batch size in a case where stochastic optimization is performed), k represents a serial number of the image data, ∥.∥₂ represents an L₂ norm, yₖ represents an intensity score corresponding to the k-th image data, and yₖ with a hat symbol (\hat{ }) represents a predicted intensity score predicted from the k-th image data.

Briefly, the first loss calculation unit 220 calculates the second partial loss by using a method of reducing a difference between an intensity score corresponding to image data and a predicted intensity score predicted from the image data (for example, L2 loss).

The first loss calculation unit 220 calculates a first loss which is a coupling loss based on the first partial loss and the second partial loss. The first loss L₁ can be obtained by, for example, the following Expression (4).

$${L}_{1} = {PL}_{1} + {PL}_{2} \qquad ( 4 )$$

The model update unit 230 receives the first loss from the first loss calculation unit 220. The model update unit 230 updates the first machine learning model using the first loss. The model update unit 230 outputs the updated parameters of the first machine learning model to the model storage 240.

Specifically, the model update unit 230 applies an optimization parameter based on the first loss to the first machine learning model to update the parameter of the first machine learning model. The optimization parameter is set by the first training condition.

The model storage 240 receives the parameters of the first machine learning model from the model update unit 230. The model storage 240 stores the first machine learning model updated based on the parameter.

Briefly describing the above, the first training unit 120 learns the first machine learning model (first training model) using a plurality of subject data based on the first training criterion configured by a plurality of training elements related to the subject data, and generates a plurality of first feature vectors corresponding to the plurality of subject data. Furthermore, the first training criterion includes a first training element and a second training element, the first training element is a combination of first data (for example, image data) and a first loss function (for example, SimCLR) corresponding to first training (for example, unsupervised learning) using the first data, and the second training element is a combination of second data (for example, the intensity score) and a second loss function (for example, L2 loss) corresponding to second training (for example, supervised learning) using the second data.

The first clustering unit 130 receives a plurality of first feature vectors from the first training unit 120. The first clustering unit 130 generates a first clustering result by clustering a plurality of first feature vectors. The first clustering unit 130 outputs the first clustering result to the comparison unit 160.

As a clustering method, for example, K-Means clustering is used. The first clustering unit 130 clusters a plurality of first feature vectors using, for example, the K-Means method to generate first clustering results of an arbitrary number of clusters. Any number of clusters may be designated by the user or may be designated by using a cluster number estimation technique, for example. Examples of the cluster number estimation technique include an elbow method and silhouette analysis.

The first clustering result includes, for example, a first cluster number that is an ID of a cluster to which the first feature vector belongs. Specifically, the first clustering result includes, for example, data in which the first feature vector and the first cluster number are associated with each other. Furthermore, for example, the first clustering result may include data in which the first feature vector, the subject data corresponding to the first feature vector, and the cluster number are associated with each other.

In addition, the first clustering unit 130 may assign a first cluster label corresponding to the first cluster number. Examples of the assignment of the first cluster label include manual assignment by a user and automatic assignment using machine learning or the like. In the manual assignment, a user checks data (image) included in a cluster, and assigns, for example, a first cluster label indicating a feature of the image to each cluster. In the automatic assignment, an image included in a cluster is analyzed using machine learning or the like, and a first cluster label is automatically assigned. Therefore, the first clustering result may include data in which the first feature vector and the first cluster label are associated with each other. In addition, the first clustering result may include data in which the first feature vector, the subject data corresponding to the first feature vector, and the first cluster label are associated with each other.

The second training unit 140 receives a plurality of items of subject data from the acquisition unit 110. The second training unit 140 learns the second machine learning model under the second training condition using the plurality of subject data. The second training condition includes a second training criterion to be described later. The second training unit 140 outputs a plurality of second feature vectors by inputting a plurality of items of subject data to a second trained model that is a second machine learning model for which training has been completed. The second training unit 140 outputs the plurality of second feature vectors to the second clustering unit 150.

Furthermore, in a case where the acquisition unit 110 has acquired the second training condition, the second training unit 140 may receive the second training condition from the acquisition unit 110. In addition, the second training unit 140 may set a second training condition for training the second machine learning model. Hereinafter, a specific configuration of the second training unit 140 will be described with reference to FIG. 3.

FIG. 3 is a block diagram illustrating a specific configuration of the second training unit in FIG. 1. The second training unit 140 in FIG. 3 includes a second feature vector calculation unit 310, a second loss calculation unit 320, a model update unit 330, and a model storage 340. In each of the following units, processing of one subject data of the plurality of items of subject data will be described.

The second feature vector calculation unit 310 calculates a second feature vector based on the subject data. Specifically, the second feature vector calculation unit 310 outputs (calculates) the second feature vector by inputting the subject data to the second machine learning model stored in the model storage 340. The second feature vector calculation unit 310 outputs the calculated second feature vector to the second loss calculation unit 320. Note that, in the present embodiment, the second feature vector is, for example, 128 dimensional vector data output from the output layer of the DNN.

Note that the second feature vector calculation unit 310 outputs the second feature vector output from the output layer of the DNN in the calculation of the second loss by training of the second machine learning model. On the other hand, after training of the second machine learning model, the second feature vector calculation unit 310 may output the output of the intermediate layer before the output layer (for example, several layers before the output layer) as the second feature vector.

The second loss calculation unit 320 receives the second feature vector from the second feature vector calculation unit 310. The second loss calculation unit 320 calculates the second loss using the second feature vector. The second loss calculation unit 320 outputs the second loss to the model update unit 330.

Specifically, the second loss calculation unit 320 calculates the second loss L₂ using SimCLR, which is one of unsupervised learning methods, for example. That is, the second loss L₂ corresponds to only the first partial loss PL₁ described in the first loss calculation unit 220, and is calculated for the image data (the material texture pattern of the SEM image) based on the first training element, for example.

The model update unit 330 receives the second loss from the second loss calculation unit 320. The model update unit 330 updates the second machine learning model using the second loss. The model update unit 330 outputs the parameters of the updated second machine learning model to the model storage 340.

Specifically, the model update unit 330 applies the optimization parameter based on the second loss to the second machine learning model to update the parameter of the second machine learning model. The optimization parameter is set by the second training condition.

The model storage 340 receives the parameter of the second machine learning model from the model update unit 330. The model storage 340 stores the second machine learning model updated based on the parameter.

Briefly describing the above, the second training unit 140 learns a second machine learning model (second training model) using a plurality of subject data based on a second training criterion different from the first training criterion, and generates a plurality of second feature vectors corresponding to the plurality of subject data. Furthermore, the second training criterion includes a first training element, and the first training element is a combination of first data (for example, image data) and a first loss function (for example, SimCLR) corresponding to first training (for example, unsupervised learning) using the first data.

The second clustering unit 150 receives a plurality of second feature vectors from the second training unit 140. The second clustering unit 150 generates a second clustering result by clustering a plurality of second feature vectors. The second clustering unit 150 outputs the second clustering result to the comparison unit 160.

As a clustering method, for example, K-Means clustering is used. The second clustering unit 150 clusters a plurality of second feature vectors using, for example, the K-Means method to generate second clustering results of an arbitrary number of clusters. Any number of clusters may be designated by the user or may be designated by using a cluster number estimation technique, for example. Examples of the cluster number estimation technique include an elbow method and silhouette analysis.

The second clustering result includes, for example, a second cluster number that is an ID of a cluster to which the second feature vector belongs. Specifically, the second clustering result includes, for example, data in which the second feature vector and the second cluster number are associated with each other. Furthermore, for example, the second clustering result may include data in which the second feature vector, subject data corresponding to the second feature vector, and a cluster number are associated with each other.

In addition, the second clustering unit 150 may assign a second cluster label corresponding to the second cluster number. Examples of the assignment of the second cluster label include manual assignment by the user and automatic assignment using machine learning or the like. In the manual assignment, a user checks data (image) included in a cluster, and assigns, for example, a second cluster label indicating a feature of the image to each cluster. In the automatic assignment, an image included in a cluster is analyzed using machine learning or the like, and a second cluster label is automatically assigned. Therefore, the second clustering result may include data in which the second feature vector and the second cluster label are associated with each other. In addition, the second clustering result may include data in which the second feature vector, the subject data corresponding to the second feature vector, and the second cluster label are associated with each other.

The comparison unit 160 receives the first clustering result from the first clustering unit 130 and receives the second clustering result from the second clustering unit 150. The comparison unit 160 generates a comparison result by comparing the first clustering result with the second clustering result. The comparison unit 160 outputs the comparison result to the display control unit 170.

Specifically, for example, the comparison unit 160 generates a comparison result by calculating a ratio of the number of samples of the second feature vector included in one cluster to be compared in the second clustering result to the number of samples of the first feature vector included in the plurality of clusters to be compared in the first clustering result.

Furthermore, for example, the comparison unit 160 may generate the comparison result by calculating the number of samples of a product set of samples of the first feature vectors included in a plurality of clusters to be compared in the first clustering result and samples of the second feature vectors included in one cluster to be compared in the second clustering result.

Furthermore, for example, the comparison unit 160 may generate a comparison result by calculating intersection over union (IoU) based on the number of samples of a product set and the number of samples of a sum set of samples of first feature vectors included in a plurality of clusters to be compared in the first clustering result and samples of second feature vectors included in one cluster to be compared in the second clustering result.

Each of the ratio of the number of samples, the number of samples of the product set, and the IoU calculated by the comparison unit 160 may be referred to as a cluster integration degree. The cluster to be compared may be arbitrarily selected by the user. In a case where the user does not select the cluster to be compared, a combination of the cluster of the first clustering result and the cluster of the second clustering result having the largest degree of cluster integration may be selected as the cluster to be compared. Therefore, the comparison unit 160 may calculate the degree of cluster integration based on one cluster of the first clustering result and a plurality of clusters of the second clustering result.

Furthermore, the comparison unit 160 may generate a scatter diagram in order to visualize the clustering result. Specifically, the comparison unit 160 uses a dimension reduction method such as PCA, t-SNE, or UMAP to represent feature vectors by a plurality of different components, and generates a scatter diagram in which each point of the feature vectors is grouped for each cluster based on a clustering result. In a case where there are two different components, the comparison unit 160 generates a two-dimensional scatter diagram. In a case where the number of different components is three, the comparison unit 160 generates a three-dimensional scatter diagram. The grouping means, for example, distinguishing each cluster. For example, the comparison unit 160 generates a scatter diagram that can identify each cluster by displaying coordinate points corresponding to feature vectors in different colors and shapes for each cluster.

The display control unit 170 receives the comparison result from the comparison unit 160. The display control unit 170 displays the comparison result on the display, for example. Furthermore, for example, the display control unit 170 may display a display image including a scatter diagram in which at least one of the plurality of first feature vectors and the plurality of second feature vectors is represented by a plurality of different components. The display image described above may include, for example, a scatter diagram and image data corresponding to samples included in the scatter diagram.

Furthermore, for example, the display control unit 170 may display a display image including at least one of a first scatter diagram in which each point of the plurality of first feature vectors is grouped for each cluster based on the first clustering result and a second scatter diagram in which each point of the plurality of second feature vectors is grouped for each cluster based on the second clustering result.

For example, when the display image including the first scatter diagram and the second scatter diagram is displayed, the display control unit 170 may include a figure indicating a correspondence relationship between a plurality of clusters of the first scatter diagram and one cluster of the second scatter diagram on the display image. The figure is, for example, a line (for example, a double-headed arrow line) crossing the first scatter diagram and the second scatter diagram, and a surrounding line surrounding each of a plurality of clusters in the first scatter diagram and one cluster in the second scatter diagram.

The data analysis apparatus 100 may include a memory and a processor. The memory stores, for example, various programs (for example, the data analysis program) related to the operation of the data analysis apparatus 100. The processor reads and executes various programs stored in the memory, thereby implementing the functions of the acquisition unit 110, the first training unit 120, the first clustering unit 130, the second training unit 140, the second clustering unit 150, the comparison unit 160, and the display control unit 170.

In addition, the data analysis apparatus 100 does not need to be physically configured by one computer, and may be configured by a computer system (for example, a data analysis system) including a plurality of computers communicably connected via a wired or network line or the like. The assignment of the series of processing according to the embodiment to a plurality of processors mounted on a plurality of computers can be optionally set. All the processors may execute all the processing in parallel, or specific processing may be assigned to one or some of the processors, and a series of processing according to the embodiment may be executed as the entire computer system. Typically, an external computer may play the roles of the first training unit 120 and the second training unit 140 in the embodiment.

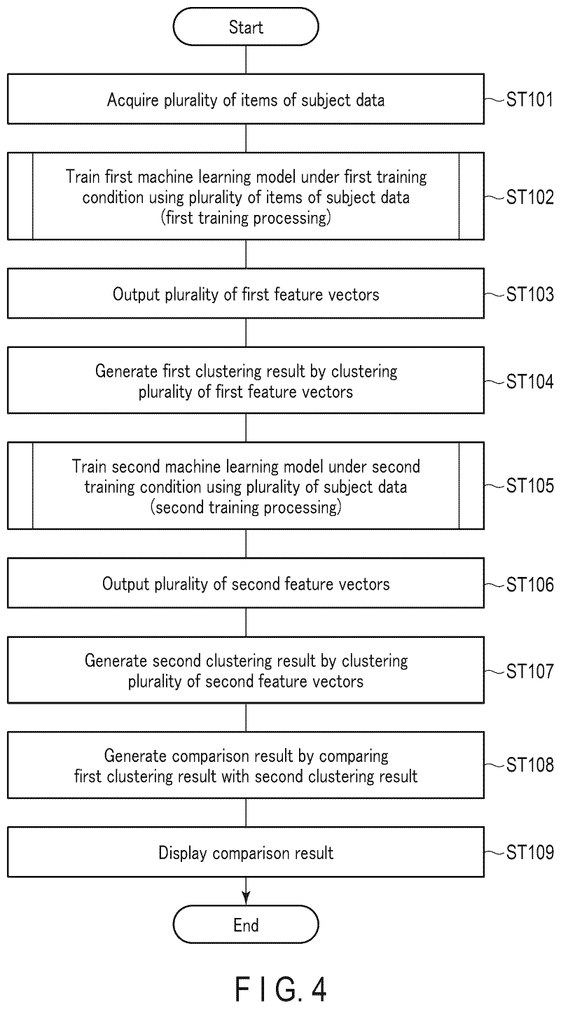

The configuration of the data analysis apparatus 100 according to the embodiment has been described above. Next, the operation of the data analysis apparatus 100 according to the embodiment will be described with reference to the flowchart of FIG. 4.

FIG. 4 is a flowchart illustrating an operation of the data analysis apparatus according to the embodiment. The processing of the flowchart of FIG. 4 starts, for example, if a data analysis program is selected by the user and the data analysis program is executed by the processor.

### (Step ST101)

The acquisition unit 110 acquires a plurality of items of subject data. Hereinafter, it is assumed that the subject data is an image including one or more figures of either a perfect circle or an ellipse and a flexural strength score corresponding to the image.

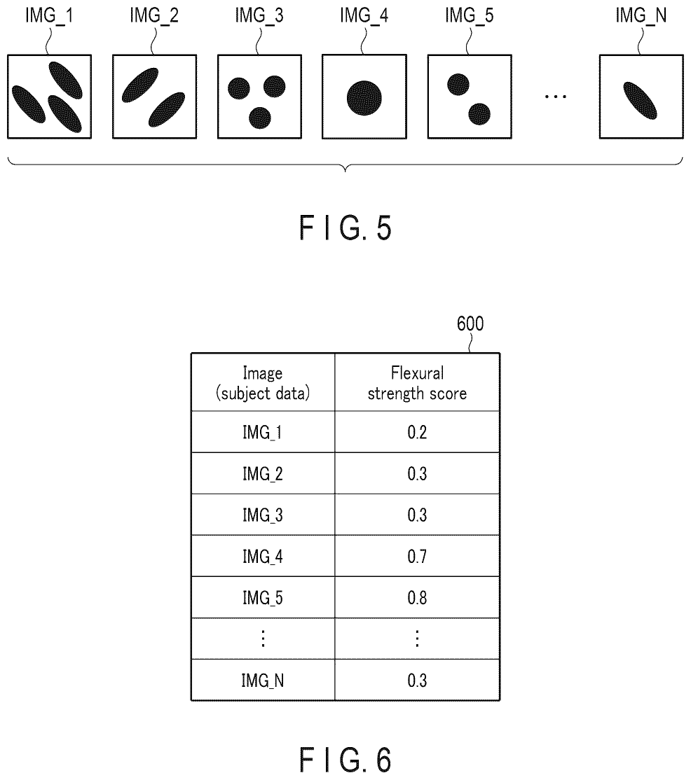

Hereinafter, the image of the subject data will be described with reference to FIG. 5, and the flexural strength score of the subject data will be described with reference to FIG. 6.

FIG. 5 is a diagram illustrating a specific example of an image in the embodiment. FIG. 5 illustrates, as variations of an image including either a true circle or an ellipse, an image IMG_1 (three ellipses), an image IMG_2 (two ellipses), an image IMG_3 (three true circles), an image IMG_4 (one true circle), an image IMG_5 (two true circles), . . . , and an image IMG N (one ellipse). Note that N is the total number of items of image data.

FIG. 6 is a table in which an image and a flexural strength score are associated with each other according to the embodiment. In a table 600 of FIG. 6, an image “IMG_1” and a flexural strength score “0.2”, an image “IMG 2” and a flexural strength score “0.3”, an image “IMG 3” and a flexural strength score “0.3”, an image “IMG 4” and a flexural strength score “0.7”, an image “IMG 5” and a flexural strength score “0.8”, . . . , an image “IMG N” and a flexural strength score “0.3” are associated with each other.

In the following description, a first training criterion considers both an image of FIG. 5 and a flexural strength score of FIG. 6, and a second training criterion considers only the image of FIG. 5.

### (Step ST102)

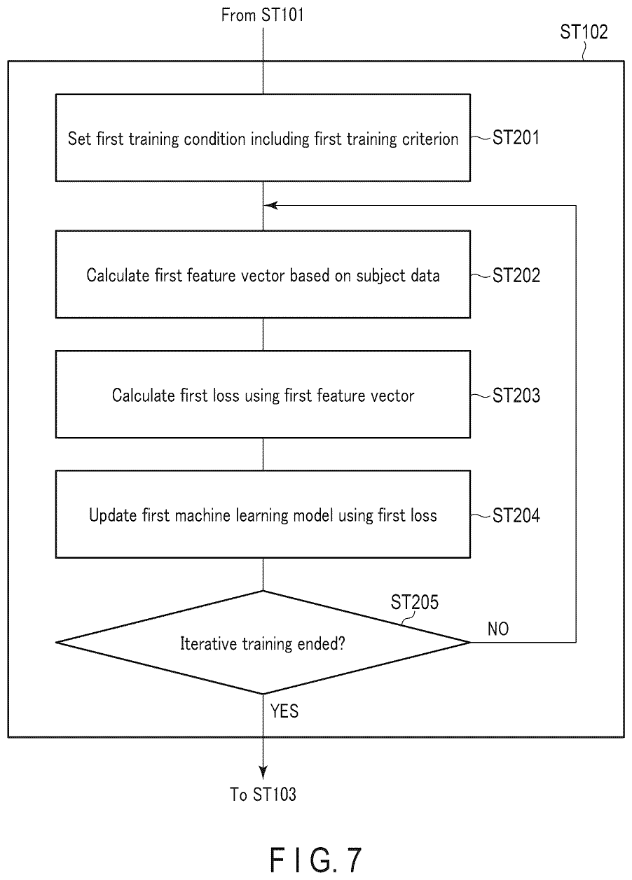

After the acquisition unit 110 acquires the plurality of subject data, the first training unit 120 trains the first machine learning model under the first training condition using the plurality of subject data. Hereinafter, the processing of step ST102 is referred to as “first training processing”. Hereinafter, a specific example of the first training processing will be described with reference to the flowchart of FIG. 7.

FIG. 7 is a flowchart illustrating a specific example of the first training processing of the flowchart of FIG. 4. The flowchart of FIG. 7 transitions from step ST101 of the flowchart of FIG. 4.

### (Step ST201)

After the acquisition unit 110 acquires the plurality of items of subject data, the first training unit 120 sets the first training condition including the first training criterion. As described above, the first training criterion aims to reduce the first loss calculated using the first training element and the second training element.

### (Step ST202)

After the first training unit 120 sets the first training condition, the first feature vector calculation unit 210 calculates the first feature vector based on the subject data.

### (Step ST203)

After the first feature vector calculation unit calculates the first feature vector, the first loss calculation unit 220 calculates the first loss using the first feature vector.

### (Step ST204)

After the first loss calculation unit 220 calculates the first loss, the model update unit 230 updates the first machine learning model using the first loss.

Note that it is preferable to perform “iterative training” (probabilistic optimization) by repeating the processing from step ST202 to step ST204 described above on subset data (mini-batch) randomly selected from a plurality of subject data without duplication. Further, a cycle of processing for all of the plurality of items of subject data is expressed as “one epoch”. For convenience of description, it is assumed that the processing for all the plurality of items of subject data has made a round, and the processing proceeds to step ST205.

### (Step ST205)

After the processing for all of the plurality of items of subject data has made a round, the first training unit 120 determines whether to end the iterative training. In this determination, for example, a predetermined number of epochs may be used as the end condition. In a case where it is determined not to end the iterative training, the processing returns to step ST202. In a case where it is determined to end the iterative training, the processing proceeds to step ST103.

### (Step ST103)

After the first training processing is performed, the first training unit 120 outputs a plurality of first feature vectors. Specifically, the first training unit 120 outputs a plurality of first feature vectors by inputting a plurality of items of subject data to a first trained model that is a first machine learning model for which training has been completed by the first training processing.

### (Step ST104)

After the first training unit 120 outputs the plurality of first feature vectors, the first clustering unit 130 generates a first clustering result by clustering the plurality of first feature vectors.

### (Step ST105)

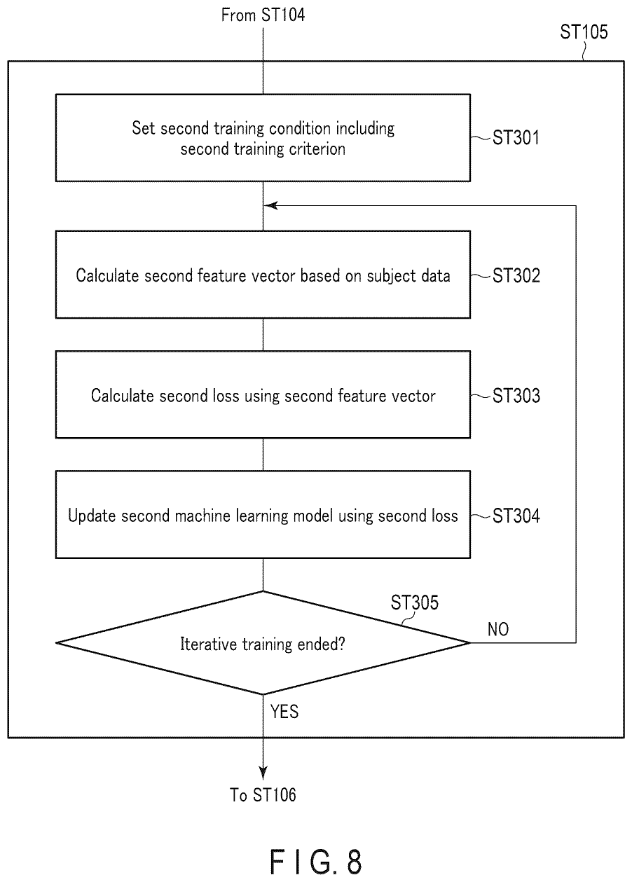

After the first clustering unit 130 generates the first clustering result, the second training unit 140 learns the second machine learning model under the second training condition using the plurality of subject data. Hereinafter, the processing of step ST105 is referred to as “second training processing”. Hereinafter, a specific example of the second training processing will be described with reference to the flowchart of FIG. 8.

FIG. 8 is a flowchart illustrating a specific example of the second training processing of the flowchart of FIG. 4. The flowchart of FIG. 8 transitions from step ST104 of the flowchart of FIG. 4.

### (Step ST301)

After the first clustering unit 130 generates the first clustering result, the second training unit 140 sets the second training condition including the second training criterion. As described above, an object of the second training criterion is to reduce the second loss calculated using the first training element.

### (Step ST302)

After the second training unit 140 sets the second training condition, the second feature vector calculation unit 310 calculates the second feature vector based on the subject data.

### (Step ST303)

After the second feature vector calculation unit 310 calculates the second feature vector, the second loss calculation unit 320 calculates the second loss using the second feature vector.

### (Step ST304)

After the second loss calculation unit 320 calculates the second loss, the model update unit 330 updates the second machine learning model using the second loss.

Note that, to be precise, “iterative training” is performed by repeating the above processing from step ST302 to step ST304 for all of the plurality of items of subject data. For convenience of description, it is assumed that the processing for all the plurality of items of subject data has made a round, and the processing proceeds to step ST305.

### (Step ST305)

After the processing for all of the plurality of items of subject data has made a round, the second training unit 140 determines whether to perform iterative training. In this determination, for example, a predetermined number of epochs may be used as the end condition. In a case where it is determined not to end the iterative training, the processing returns to step ST302. In a case where it is determined to end the iterative training, the processing proceeds to step ST106.

### (Step ST106)

After the second training processing is performed, the second training unit 140 outputs a plurality of second feature vectors. Specifically, the second training unit 140 outputs a plurality of second feature vectors by inputting a plurality of items of subject data to a second trained model that is a second machine learning model for which training has been completed by the second training processing.

### (Step ST107)

After the second training unit 140 outputs the plurality of second feature vectors, the second clustering unit 150 clusters the plurality of second feature vectors to generate a second clustering result.

### (Step ST108)

After the second clustering unit 150 generates the second clustering result, the comparison unit 160 compares the first clustering result with the second clustering result to generate a comparison result.

### (Step ST109)

After the comparison unit 160 generates the comparison result, the display control unit 170 displays the comparison result. Furthermore, the display control unit 170 may display a scatter diagram or the like regarding at least one of the plurality of first feature vectors and the plurality of second feature vectors. After step ST109, the processing of the flowchart of FIG. 4 ends.

Some flowcharts described above are examples. The order and the like of each step of these flowcharts may be changed as much as possible, or other steps may be added.

### (Specific Example of Display)

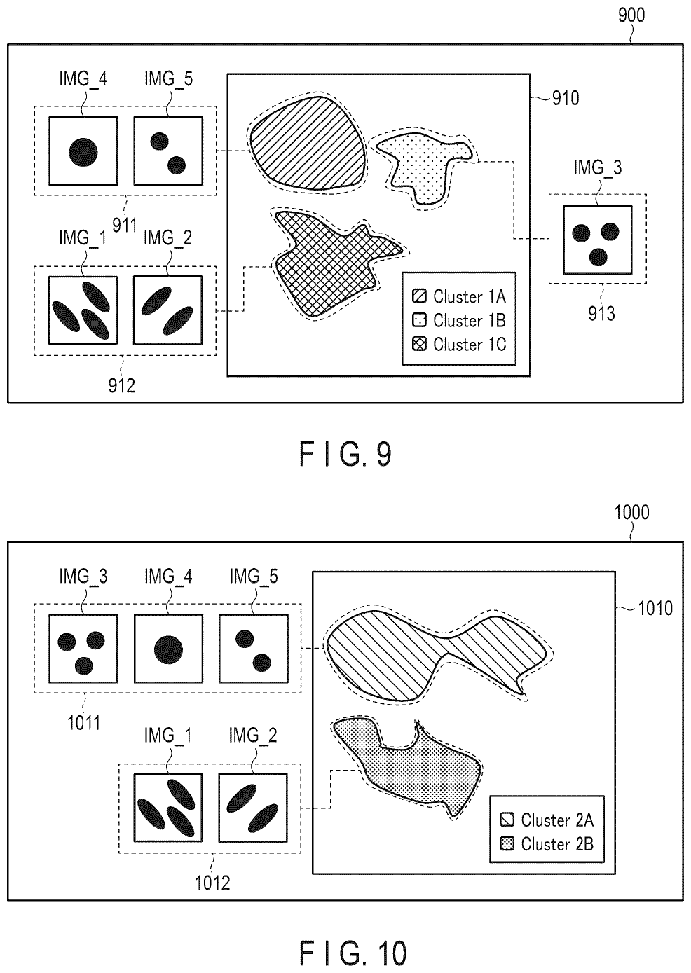

FIG. 9 is a diagram illustrating a specific example of a display image including a scatter diagram visualizing the first clustering result according to the embodiment. A display image 900 in FIG. 9 includes a scatter diagram 910, a representative image 911, a representative image 912, and a representative image 913.

The scatter diagram 910 illustrates three clusters of a cluster 1A, a cluster 1B, and a cluster 1C based on the first clustering result. In the representative image 911, an image IMG_4 and an image IMG_5 corresponding to the cluster 1A are illustrated. In the representative image 912, an image IMG_1 and an image IMG_2 corresponding to the cluster 1B are illustrated. In the representative image 913, an image IMG_3 corresponding to the cluster 1C is illustrated.

FIG. 10 is a diagram illustrating a specific example of a display image including a scatter diagram visualizing the second clustering result according to the embodiment. A display image 1000 in FIG. 10 includes a scatter diagram 1010, a representative image 1011, and a representative image 1012.

The scatter diagram 1010 illustrates two clusters of a cluster 2A and a cluster 2B based on the second clustering result. In the representative image 1011, an image IMG_3, an image IMG_4, and an image IMG_5 corresponding to the cluster 2A are illustrated. In the representative image 1012, an image IMG_1 and an image IMG_2 corresponding to the cluster 2B are illustrated. According to FIGS. 9 and 10, the first clustering result based on the first training criterion is divided into three clusters, and the second clustering result based on the second training criterion is divided into two clusters. In addition, it can be seen that the representative image of the cluster 2A in the scatter diagram 1010 of the second clustering result includes the respective representative images of the clusters 1A and 1B in the scatter diagram 910 of the first clustering result. From this, it can be seen that the factor that has divided the clusters 1A and 1B as the first clustering result is the second training element (strength score) in the first training criterion.

Briefly, the display control unit 170 displays the display image 900 or the display image 1000 including one of a scatter diagram 910 (first scatter diagram) in which each point of the plurality of first feature vectors is grouped for each cluster based on the first clustering result and a scatter diagram 1010 (second scatter diagram) in which each point of the plurality of second feature vectors is grouped for each cluster based on the second clustering result.

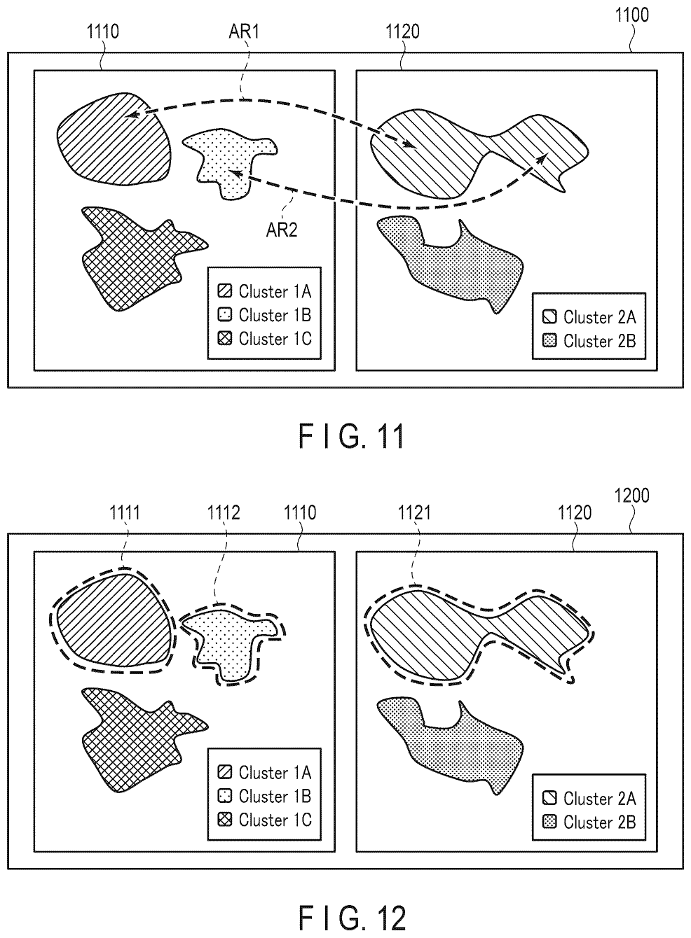

FIG. 11 is a diagram illustrating a first specific example of a display image including a figure indicating a correspondence relationship between different scatter diagrams in the embodiment. The display image 1100 in FIG. 11 includes a scatter diagram 1110, a scatter diagram 1120, a double-headed arrow line AR1, and a double-headed arrow line AR2.

The scatter diagram 1110 is similar to the scatter diagram 910 of FIG. 9 in which the first clustering result is visualized. The scatter diagram 1120 is similar to the scatter diagram 1010 of FIG. 10 in which the second clustering result is visualized. The double-headed arrow line AR1 is displayed so as to associate the cluster 1A of the scatter diagram 1110 with the cluster 2A of the scatter diagram 1120. The double-headed arrow line AR2 is displayed so as to associate the cluster 1B of the scatter diagram 1110 with the cluster 2A of the scatter diagram 1120.

According to FIG. 11, the user can recognize the cluster 1A, the cluster 1B, and the cluster 2A as clusters to be compared by visually recognizing the double-headed arrow line AR1 and the double-headed arrow line AR2.

Briefly, the display control unit 170 displays the display image 1100 including the scatter diagram 1110 (first scatter diagram) and the scatter diagram 1120 (second scatter diagram). The display image 1100 includes a double-headed arrow line crossing the first scatter diagram and the second scatter diagram as a figure indicating a correspondence relationship between a plurality of clusters in the first scatter diagram and one cluster in the second scatter diagram.

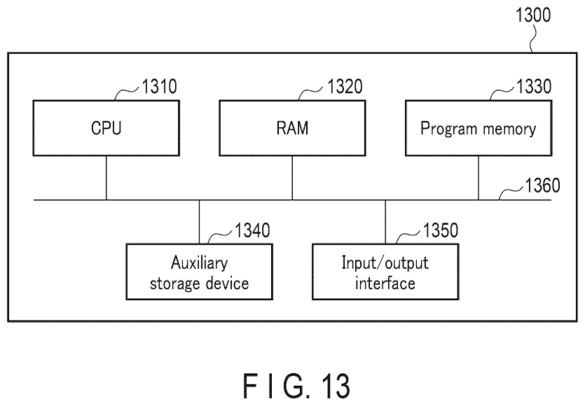

FIG. 12 is a diagram illustrating a second specific example of a display image including a figure indicating a correspondence relationship between different scatter diagrams in the embodiment. A display image 1200 of FIG. 12 includes a scatter diagram 1110, a scatter diagram 1120, a surrounding line 1111, a surrounding line 1112, and a surrounding line 1121.

The surrounding line 1111 is a line surrounding the outer edge of the cluster 1A. The surrounding line 1112 is a line surrounding the outer edge of the cluster 1B. The surrounding line 1121 is a line surrounding the outer edge of the cluster 2A. The surrounding line 1111, the surrounding line 1112, and the surrounding line 1121 are configured with the same line type and line color, respectively.

According to FIG. 12, the user can recognize the clusters 1A and 1B and the cluster 2A as a cluster to be compared by visually recognizing the surrounding lines 1111, 1112, and 1121.

Briefly, the display control unit 170 displays the display image 1200 including the scatter diagram 1110 (first scatter diagram) and the scatter diagram 1120 (second scatter diagram). The display image 1200 includes surrounding lines surrounding the plurality of clusters in the first scatter diagram and one cluster in the second scatter diagram as a figure indicating a correspondence relationship between the plurality of clusters in the first scatter diagram and one cluster in the second scatter diagram.

As described above, the data analysis apparatus according to the embodiment acquires a plurality of items of subject data, trains a first training model using the plurality of items of subject data based on a first training criterion including a plurality of training elements related to the subject data, and generates a plurality of first feature vectors corresponding to the plurality of items of subject data, generates a first clustering result by clustering the plurality of first feature vectors, trains a second training model using the plurality of items of subject data based on a second training criterion different from the first training criterion, and generates a plurality of second feature vectors corresponding to the plurality of items of subject data, and generates a comparison result by comparing the plurality of first feature vectors and the plurality of second feature vectors for each of a plurality of clusters based on the first clustering result.

Therefore, the data analysis apparatus according to the embodiment can estimate the influence of the training criterion on the clustering by comparing the feature vectors generated from the training models having different training criteria.

### (Modification 1)

The data analysis apparatus according to the above embodiment uses the “combination of the SEM image and the flexural strength score” as a specific example of the subject data, but the present invention is not limited thereto. For example, as specific examples of the subject data, “combination of SEM image and thermal conductivity and electrical conductivity”, “combination of leaf image with presence or absence of disease, degree of progression, and type”, “combination of pathological image with presence or absence of disease, degree of progression, and type”, “combination of aerial photograph and population density”, “combination of speech data and audience number”, and “combination of sensor data and presence or absence of accident and weather” may be used.

### (Modification 2)

The data analysis apparatus according to the above embodiment uses DNN as machine learning, but the present invention is not limited thereto. For example, any machine learning model such as linear regression, multiple regression, support vector machine (SVM), and a decision tree may be used as the machine learning.

### (Modification 3)

The data analysis apparatus according to the third modification may cause the second machine learning model to learn using a plurality of items of subject data with the parameter of the first trained model, which is the first machine learning model for which training has been completed, as an initial stage. As a result, the data analysis apparatus according to the third modification can shorten the time required for training the second machine learning model.

### (Modification 4)

A data analysis apparatus according to a fourth modification may learn the second machine learning model by performing additional training on the cluster to be compared using the parameter of the first trained model as an initial value. Specifically, the data analysis apparatus according to the fourth modification may cause the second machine learning model to learn by additional training limited to only subject data (samples) included in the cluster to be compared or samples around the cluster to be compared, with the parameter of the first trained model as an initial value. As a result, the data analysis apparatus according to the fourth modification narrows down the clusters to be processed and performs training, so that the time required for analysis can be shortened.

### (Modification 5)

The data analysis apparatus according to the above embodiment generates the second clustering result, but the present invention is not limited thereto. In a case where the second clustering result is not generated, the comparison unit in the data analysis apparatus according to the fifth modification may generate the comparison result by comparing the plurality of first feature vectors and the plurality of second feature vectors for each of the plurality of clusters based on the first clustering result. Specifically, the comparison unit in the data analysis apparatus according to the fifth modification calculates a distance between the clusters included in the first clustering result with a plurality of first feature vectors and a plurality of second feature vectors, and compares the distance between the first clusters based on the plurality of first feature vectors with the distance between the second clusters based on the plurality of second feature vectors to generate a comparison result. Accordingly, in the data analysis apparatus according to the fifth modification, if the distance between the first clusters is dominantly larger than the distance between the second clusters in the clusters to be compared, it can be seen that the separation of the clusters to be compared is not caused by the second training criterion.

### (Hardware Configuration)

FIG. 13 is a block diagram illustrating a hardware configuration of a computer according to an embodiment. A computer 1300 includes, as hardware, a central processing unit (CPU) 1310, a random access memory (RAM) 1320, a program memory 1330, an auxiliary storage device 1340, and an input/output interface 1350. The CPU 1310 communicates with the RAM 1320, the program memory 1330, the auxiliary storage device 1340, and the input/output interface 1350 via a bus 1360.

The CPU 1310 is an example of a general-purpose processor. The RAM 1320 is used as a working memory for the CPU 1310. The RAM 1320 includes a volatile memory such as a synchronous dynamic random access memory (SDRAM). The program memory 1330 stores various programs including a data analysis program. As the program memory 1330, for example, a read-only memory (ROM), a part of the auxiliary storage device 1340, or a combination thereof is used. The auxiliary storage device 1340 non-temporarily stores data. The auxiliary storage device 1340 includes a nonvolatile memory such as an HDD or an SSD.

The input/output interface 1350 is an interface for connecting to or communicating with another device. The input/output interface 1350 is used, for example, for connection or communication between the acquisition unit 110 and an external device (for example, an input/output device and a server device) illustrated in FIG. 1, connection or communication between the display control unit 170 and an external device.

Each program stored in the program memory 1330 includes a computer-executable instruction. If executed by the CPU 1310, the program (computer-executable instruction) causes the CPU 1310 to execute predetermined processing. For example, if the data analysis program is executed by the CPU 1310, the data analysis program causes the CPU 1310 to execute a series of processing described with respect to each unit of FIGS. 1, 2, and 3.

The program may be provided to the computer 1300 in a state of being stored in a computer-readable storage medium. In this case, for example, the computer 1300 further includes a drive (not illustrated) that reads data from the storage medium, and acquires the program from the storage medium. Examples of the storage medium include a magnetic disk, an optical disk (CD-ROM, CD-R, DVD-ROM, DVD-R, and the like), a magneto-optical disk (MO or the like), and a semiconductor memory. In addition, the program may be stored in a server on the communication network, and the computer 1300 may download the program from the server using the input/output interface 1350.

The processing described in the embodiment is not limited to being performed by a general-purpose hardware processor such as the CPU 1310 executing a program, and may be performed by a dedicated hardware processor such as an application specific integrated circuit (ASIC). The term processing circuit (processing unit) includes at least one general purpose hardware processor, at least one special purpose hardware processor, or a combination of at least one general purpose hardware processor and at least one special purpose hardware processor. In the example illustrated in FIG. 13, the CPU 1310, the RAM 1320, and the program memory 1330 correspond to a processing circuit.

Therefore, according to each embodiment described above, it is possible to estimate the influence of the training criterion on clustering.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data analysis apparatus comprising processing circuitry configured to:
acquire a plurality of items of subject data;
train a first training model using the items of subject data based on a first training criterion including a plurality of training elements related to the items of subject data, and generate a plurality of first feature vectors corresponding to the items of subject data;
generate a first clustering result by clustering the plurality of first feature vectors;
train a second training model using the items of subject data based on a second training criterion different from the first training criterion, and generate a plurality of second feature vectors corresponding to the items of subject data; and
generate a comparison result by comparing the plurality of first feature vectors and the plurality of second feature vectors for each of a plurality of clusters based on the first clustering result.

2. The data analysis apparatus according to claim 1, wherein
the subject data includes first data and second data associated with the first data,
the first training criterion includes a first training element and a second training element,
the first training element is a combination of the first data and a first loss function corresponding to first training using the first data, and
the second training element is a combination of the second data and a second loss function corresponding to second training using the second data.

3. The data analysis apparatus according to claim 2, wherein
the first learning is either unsupervised learning or supervised learning, and
the second training is either unsupervised learning or supervised learning.

4. The data analysis apparatus according to claim 2, wherein
the first training criterion includes a regularization term for at least one of the first loss function and the second loss function.

5. The data analysis apparatus according to claim 2, wherein
the second training criterion includes the first training element or the second training element.

6. The data analysis apparatus according to claim 1, the processing circuitry is further configured to learn the second training model using the items of subject data with a parameter of the first training model for which training has been completed as an initial value.

7. The data analysis apparatus according to claim 1, the processing circuitry is further configured to learn the second training model by performing additional training on one or more clusters selected from the first clustering result, with a parameter of the first training model for which training has been completed as an initial value.

8. The data analysis apparatus according to claim 1, the processing circuitry is further configured to calculate a distance between each cluster included in the first clustering result by each of the plurality of first feature vectors and the plurality of second feature vectors, and generate the comparison result by comparing a first inter-cluster distance based on the plurality of first feature vectors with a second inter-cluster distance based on the plurality of second feature vectors.

9. The data analysis apparatus according to claim 1, the processing circuitry is further configured to
generate a second clustering result by clustering the second feature vectors, and
generate the comparison result by comparing the first clustering result with the plurality of second clustering result.

10. The data analysis apparatus according to claim 9, the processing circuitry is further configured to generate the comparison result by calculating a ratio of the number of samples of second feature vectors included in one cluster to be compared in the second clustering result to the number of samples of first feature vectors included in a plurality of clusters to be compared in the first clustering result.

11. The data analysis apparatus according to claim 9, the processing circuitry is further configured to generate the comparison result by calculating the number of samples of a product set of samples of first feature vectors included in a plurality of clusters to be compared in the first clustering result and samples of second feature vectors included in one cluster to be compared in the second clustering result.

12. The data analysis apparatus according to claim 9, the processing circuitry is further configured to generate the comparison result by calculating Intersection over Union (IoU) based on the number of samples of a product set and the number of samples of a sum set of samples of first feature vectors included in a plurality of clusters to be compared in the first clustering result and samples of second feature vectors included in one cluster to be compared in the second clustering result.

13. The data analysis apparatus according to claim 1, the processing circuitry is further configured to display a display image including a scatter diagram in which at least one of the plurality of first feature vectors and the plurality of second feature vectors is represented by a plurality of different components.

14. The data analysis apparatus according to claim 13, the processing circuitry is further configured to display the display image including the scatter diagram in which each point of the feature vector is grouped for each cluster based on the first clustering result.

15. The data analysis apparatus according to claim 9, the processing circuitry is further configured to display a display image including a scatter diagram in which at least one of the plurality of first feature vectors and the plurality of second feature vectors is represented by a plurality of different components.

16. The data analysis apparatus according to claim 15, the processing circuitry is further configured to display the display image including at least one of a first scatter diagram in which each point of the plurality of first feature vectors is grouped for each cluster based on the first clustering result and a second scatter diagram in which each point of the plurality of second feature vectors is grouped for each cluster based on the second clustering result.

17. The data analysis apparatus according to claim 16, the processing circuitry is further configured to display the display image including the first scatter diagram and the second scatter diagram, and wherein the display image includes a figure indicating a correspondence relationship between a plurality of clusters of the first scatter diagram and one cluster of the second scatter diagram.

18. The data analysis apparatus according to claim 17, wherein the figure is a double-headed arrow line crossing the first scatter diagram and the second scatter diagram, and a surrounding line surrounding each of the clusters in the first scatter diagram and the one cluster in the second scatter diagram.

19. A data analysis method comprising:
acquiring a plurality of items of subject data;
training a first training model using the items of subject data based on a first training criterion including a plurality of training elements related to the subject data, and generating a plurality of first feature vectors corresponding to the items of subject data;
generating a first clustering result by clustering the plurality of first feature vectors;
training a second training model using the items of subject data based on a second training criterion different from the first training criterion, and generating a plurality of second feature vectors corresponding to the items of subject data; and
generating a comparison result by comparing the plurality of first feature vectors and the plurality of second feature vectors for each of a plurality of clusters based on the first clustering result.

20. A non-transitory computer-readable storage medium storing a program for causing a computer to execute processing comprising:
acquiring a plurality of items of subject data;
training a first training model using the items of subject data based on a first training criterion including a plurality of training elements related to the subject data, and generating a plurality of first feature vectors corresponding to the items of subject data;
generating a first clustering result by clustering the plurality of first feature vectors;
training a second training model using the items of subject data based on a second training criterion different from the first training criterion, and generating a plurality of second feature vectors corresponding to the items of subject data; and
generating a comparison result by comparing the plurality of first feature vectors and the plurality of second feature vectors for each of a plurality of clusters based on the first clustering result.
